(19) United States
(12) Patent Application Publication
(10) Pub. No.: US 2026/0228249 A1
(43) Pub. Date: Aug. 6, 2026

(54) TEXT PROCESSING DEVICE AND TEXT PROCESSING METHOD

(71) Applicant: SEMICONDUCTOR ENERGY LABORATORY CO., LTD., Atsugi-shi (JP)

(72) Inventors: Junpei MOMO, Sagamihara (JP); Tatsuya OKANO, Isehara (JP)

(21) Appl. No.: 19/451,201

(22) Filed: Jan. 16, 2026

(30) Foreign Application Priority Data
Jan. 31, 2025 (JP) 2025-014652

(51) Int. Cl. G06F 16/3329

(52) U.S. Cl. CPC G06F 16/3329; G06F 2216/11

(57) ABSTRACT

To obtain a technical feature from a claim of a patent to support comprehension of the claim. A text processing method, and a text processing device that has a function of performing processing using a language model, a function of generating a claim feature list from claim text using the language model, a function of searching a technical feature database for a technical feature similar to a claim feature in the claim feature list, a function of selecting a technical feature corresponding to the claim feature from a technical feature candidate list using the language model, and a function of outputting a technical feature list.

### BACKGROUND OF THE INVENTION

### 1. Field of the Invention

One embodiment of the present invention relates to a text processing device and a text processing method utilizing a language model, or in particular, a generative artificial intelligence (AI) model.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic appliance, a lighting device, an input device, an input/output device, driving methods thereof, and manufacturing methods thereof. The semiconductor device generally means a device that can function by utilizing semiconductor characteristics.

### 2. Description of the Related Art

In recent years, language models using neural networks have been actively developed, and especially large language models (LLM) have attracted attention. A large language model is a natural language processing model learned using a large amount of data. With a large language model, for example, an interactive model that gives an answer in response to a user's instruction can be achieved. In Non-Patent Document 1, Generative Pre-trained Transformer 4 (GPT-4, registered trademark) is disclosed as a large language model, and ChatGPT is disclosed as an interactive model.

### Reference

### Non-Patent Document 1

Summary of ChatGPT/GPT-4 Research and Perspective Towards the Future of Large Language Models, Yiheng Liu et al., (submitted on 4 April, 2023) [online], Internet URL: https://arxiv.org/abs/2304.01852

### SUMMARY OF THE INVENTION

Claims in a patent serve as a criterion for determining the scope of rights and are very important; however, the expression of claims is abstracted and it is difficult to accurately grasp the technical scope.

In view of the above, an object of one embodiment of the present invention is to obtain a technical feature from a claim of a patent and to support comprehension of the claim.

Note that the description of the above object does not preclude the existence of other objects. Objects other than the above object can be derived from the description of the specification, the drawings, the claims, and the like.

(1) One embodiment of the present invention is a text processing device that includes a first information processing device, a second information processing device, and a third information processing device. The first information processing device has a function of receiving a first instruction sentence, performing processing using a language model, and outputting a first answer sentence; and a function of receiving a second instruction sentence, performing processing using the language model, and outputting a second answer sentence. The first instruction sentence includes claim text and a first instruction, the first instruction includes an instruction to generate a claim feature list from the claim text, and the first answer sentence includes the claim feature list. The second instruction sentence includes one claim feature selected from the claim feature list, a technical feature candidate list, and a second instruction, the second instruction includes an instruction to select a technical feature corresponding to the claim feature from the technical feature candidate list, and the second answer sentence includes the technical feature. The second information processing device has a function of receiving the claim feature, searching a technical feature database for the claim feature, and outputting the technical feature candidate list. The third information processing device has a function of receiving the claim text; a function of creating the first instruction sentence; a function of transmitting the first instruction sentence to the first information processing device and receiving the first answer sentence; a function of selecting one from the claim feature list sequentially as the claim feature; a function of transmitting the claim feature to the second information processing device and receiving the technical feature candidate list; a function of creating the second instruction sentence; a function of transmitting the second instruction sentence to the first information processing device and receiving the second answer sentence; a function of adding the technical feature to a technical feature list; and a function of outputting the technical feature list.

(2) Another embodiment of the present invention is the above-described text processing device in which the second information processing device has a function of receiving the technical feature list, searching a claim database for the technical feature included in the technical feature list, and outputting a claim search result. The claim database has a function of storing the claim text, the technical feature, and an identification number linked to each other. The claim search result includes the technical feature, and the claim text and the identification number linked to the technical feature. The third information processing device has a function of transmitting the technical feature list to the second information processing device and receiving the claim search result; and a function of outputting the claim search result.

(3) One embodiment of the present invention is a text processing method that includes a step of receiving claim text; a step of creating a first instruction sentence including the claim text; a step of inputting the first instruction sentence to a language model to generate a claim feature list from the claim text; a step of selecting one claim feature from the claim feature list; a step of searching a technical feature database for the claim feature to obtain a technical feature candidate list; a step of creating a second instruction sentence including the claim feature and the technical feature candidate list; a step of inputting the second instruction sentence to the language model to select a technical feature corresponding to the claim feature from the technical feature candidate list; a step of adding the technical feature to a technical feature list; and a step of outputting the technical feature list.

(4) Another embodiment of the present invention is a text processing method that includes first to tenth steps. In the first step, claim text is received. In the second step, a first instruction sentence is created. The first instruction sentence includes the claim text and a first instruction. The first instruction includes an instruction to generate a claim feature list from the claim text. In the third step, the first instruction sentence is input to a language model and a first answer sentence is obtained. The first answer sentence includes the claim feature list. In the fourth step, one claim feature is selected from the claim feature list. In the fifth step, a technical feature database is searched for the claim feature and a technical feature candidate list is obtained. In the sixth step, a second instruction sentence is created. The second instruction sentence includes the claim feature, the technical feature candidate list, and a second instruction, and the second instruction includes an instruction to select a technical feature corresponding to the claim feature from the technical feature candidate list. In the seventh step, the second instruction sentence is input to the language model and a second answer sentence is obtained. The second answer sentence includes the technical feature. In the eighth step, the technical feature is added to a technical feature list. In the ninth step, whether all the claim features have been selected from the claim feature list is determined. The process proceeds to the tenth step when all the claim features have been selected, and the process proceeds to the fourth step when not all the claim features have been selected. In the tenth step, the technical feature list is output.

Another embodiment of the present invention is the above-described text processing method in which the ninth step is followed by an eleventh step and a twelfth step instead of the tenth step. In the eleventh step, a claim database is searched for the technical feature included in the technical feature list and a claim search result is obtained. The claim database has a function of storing the claim text, the technical feature, and an identification number linked to each other. The claim search result includes the technical feature, and the claim text and the identification number linked to the technical feature. In the twelfth step, the claim search result is output.

One embodiment of the present invention obtains a technical feature from claim text of a patent and enables deeper comprehension of what technology the claim text pertains to.

### BRIEF DESCRIPTION OF THE DRAWINGS

FIG. 1 is a schematic diagram illustrating a structure example of a text processing system.

FIG. 2 is a block diagram illustrating a structure example of a text processing device.

FIG. 3 is a block diagram illustrating an example of processing by a text processing device.

FIG. 4 is a flowchart illustrating an example of processing by a text processing method.

FIG. 5 is a flowchart illustrating an example of processing by a text processing method.

FIG. 6 is a block diagram illustrating an example of processing by a text processing device.

FIG. 7 is a flowchart illustrating an example of processing by a text processing method.

FIG. 8 is a graph illustrating an example of a claim search result output.

### DETAILED DESCRIPTION OF THE INVENTION

Embodiments will be described below with reference to the drawings. Note that the embodiments can be implemented in many different modes, and it will be readily understood by those skilled in the art that modes and details thereof can be changed in various ways without departing from the spirit and scope thereof. Therefore, the present invention should not be construed as being limited to the description of the embodiments below.

Note that in structures of the invention described below, the same portions or portions having similar functions are denoted by the same reference numeral in different drawings, and the description thereof is not repeated. Furthermore, portions having similar functions are not denoted by specific reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that ordinal numbers such as "first" and "second" in this specification and the like are used in order to avoid confusion among components and do not limit the number of components. The ordinal numbers do not denote the priority or the order such as the order of steps or the stacking order. A term without an ordinal number in this specification and the like may be provided with an ordinal number in the cope of claims in order to avoid confusion among components. A term with an ordinal number in this specification and the like may be described with a different ordinal number in the scope of claims. A term with an ordinal number in this specification and the like may be described without an ordinal number in the scope of claims.

Note that in this specification and the like, a language model is an interactive model based on a transformer architecture and obtained by additional learning. A typical language model is a large language model (LLM). The LLM performs processing based on supplied text data and is specialized for a text generation function, whereas generative AI has not only the text generation function but also an image generation function based on image data. That is, the large language model is one kind of generative AI.

### Embodiment

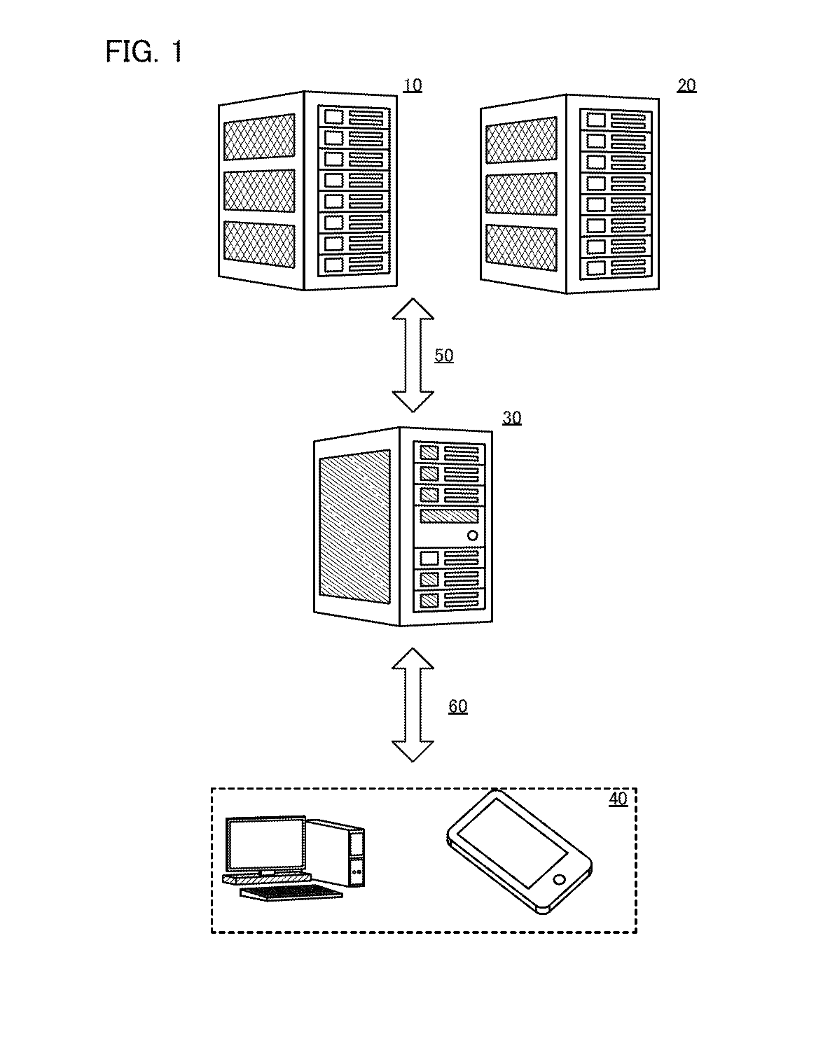

In this embodiment, a structure example of a text processing device, which is one embodiment of the present invention, is described with reference to FIG. 1.

The text processing device of one embodiment of the present invention extracts a claim feature from a claim of a patent by utilizing a language model. Furthermore, database search and the language model are utilized to convert the claim feature into a technical feature and to conduct claim labeling.

More specific examples are described below with reference to drawings.

### Structure example of text processing device

As illustrated in FIG. 1, the text processing device of this embodiment preferably includes a first information processing device 10, a second information processing device 20, a third information processing device 30, and an information terminal 40. The third information processing device 30 is connected to the first information processing device 10 and the second information processing device 20 through a network 50. The third information processing device 30 is connected to the information terminal 40 through a network 60.

For the text processing device of this embodiment, the device structure in FIG. 1 is one example; the third information processing device 30 may have a function of at least one of the first information processing device 10 and the second information processing device 20. A function of the third information processing device 30 can be dispersedly implemented in a plurality of information processing devices.

### Structure Example 1 of information terminal 40

In Structure Example 1 of the text processing device, the information terminal 40 is operated by a user and can be referred to as a client computer or the like. Although a desktop computer and a smartphone are illustrated as examples in FIG. 1, a notebook computer or a tablet computer may be used as the information terminal 40. A tablet computer may be used by being connected to a housing including an input portion (typically, a keyboard).

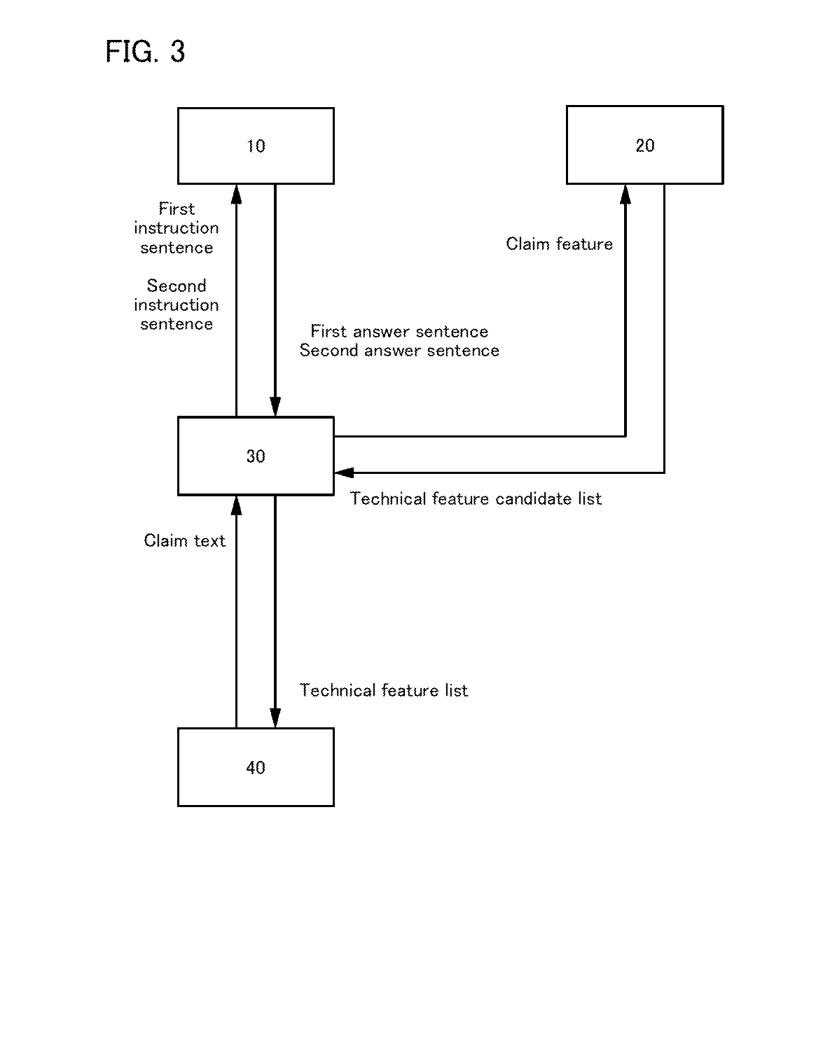

The information terminal 40 has a function of outputting claim text to the third information processing device 30. Furthermore, the information terminal 40 has a function of receiving a technical feature list from the third information processing device 30 (see FIG. 3).

Claim text is text data describing a claim of a patent.

A technical feature is text data that is registered in a technical feature database and that shows one element of a feature of a technology of a patent. A technical feature list is a list of technical features.

### Structure example of first information processing device 10

Next, a structure example of the first information processing device 10 is described.

The first information processing device 10 can perform processing using a language model. Specifically, the first information processing device 10 can perform processing using a model (a text generation model, an interactive model, or the like) utilizing a large language model. For example, processing can be executed using a large language model such as GPT-4 (registered trademark), Llama2, or Llama3. Note that in this specification and the like, the language model includes the large language model.

The first information processing device 10 has a function of receiving an instruction sentence. The first information processing device 10 has a function of outputting an answer sentence in response to the instruction sentence with the use of the language model, and can execute a variety of natural language processing tasks such as translating and summarizing.

Specifically, the first information processing device 10 has a function of receiving a first instruction sentence, inputting the first instruction sentence to the language model, and outputting a first answer sentence. The first information processing device 10 also has a function of receiving a second instruction sentence and outputting a second answer sentence (see FIG. 3).

The first instruction sentence is text data that includes claim text and a first instruction.

The first instruction is an instruction for generating a claim feature list from claim text. For example, the first instruction can be as follows: "Generate a list that itemizes technical features of the following claim."

A claim feature list is a list of claim features that is generated from claim text by the language model. A claim feature is text data describing one element of a feature of claim text relating to the technology.

The second instruction sentence is text data that includes a claim feature, a technical feature candidate list, and a second instruction.

A technical feature candidate list is a list of technical features that are similar to a claim feature among the technical features stored in the technical feature database.

The second instruction is an instruction for selecting a technical feature corresponding to a claim feature from a technical feature candidate list. For example, the second instruction can be as follows: "Select any technical feature that matches the following claim feature, from the following technical feature candidate list."

A claim feature and a technical feature, each of which is text data describing one element relating to the technology, may express essentially the same feature. However, the text data of the technical feature, which is registered in the technical feature database, and the text data of the claim feature, which is generated by the language model, are sometimes different from each other in the wording. Furthermore, some claim features are not registered in the technical feature database.

Inputting the second instruction sentence to the language model allows the language model to determine whether the claim feature matches one of technical features in a technical feature candidate list or is a new technical feature.

A service provider using the text processing device of one embodiment of the present invention does not necessarily need to own the first information processing device 10. For example, the service provider can use part of the service that is provided by another company or the like, as the first information processing device 10.

### Structure Example 1 of second information processing device 20

Next, a structure example of the second information processing device 20 is described.

The second information processing device 20 has a function of performing processing using the technical feature database.

Specifically, the second information processing device 20 has a function of receiving a claim feature, conducting a search, and outputting a technical feature candidate list of technical features similar to the claim feature (see FIG. 3).

The technical feature database is a database storing technical features of a patent. The second information processing device 20 can search the technical feature database to output technical features similar to a claim feature in the form of a technical feature candidate list.

The technical feature database may store a technical feature and a vectorized technical feature linked to each other. In that case, the second information processing device 20 has a function of receiving a vectorized claim feature, conducting a search, and outputting a technical feature similar to the claim feature.

A service provider using the text processing device of one embodiment of the present invention does not necessarily need to own the second information processing device 20. For example, the service provider can use part of the service that is provided by another company or the like, as the second information processing device 20.

### Structure Example 1 of third information processing device 30

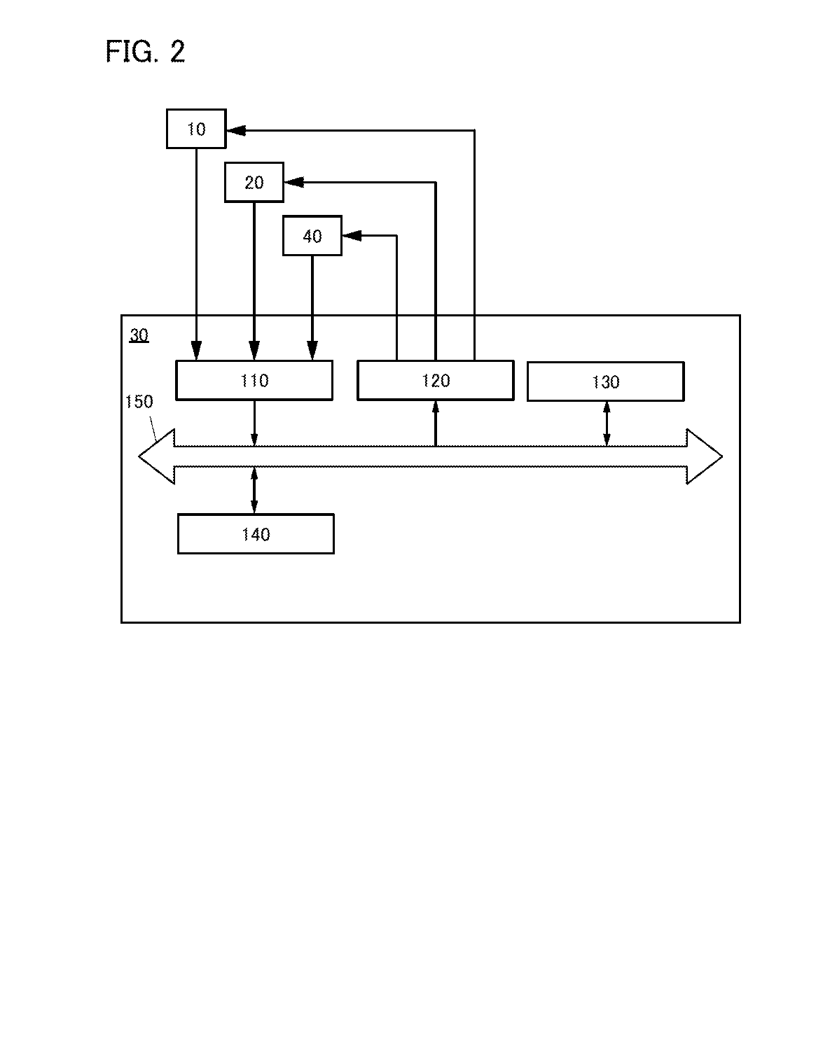

Next, a structure example of the third information processing device 30 is described with reference to FIG. 2.

As illustrated in FIG. 2, the third information processing device 30 includes a reception portion 110, an output portion 120, a memory portion 130, a processing portion 140, and a transmission path 150. FIG. 2 illustrates the information terminal 40 in addition to the first information processing device 10 and the second information processing device 20, and arrows indicate data transmission and reception. The reception portion 110 and the output portion 120 are collectively referred to as a communication portion in some cases. With the communication portion, the third information processing device 30 can transmit and receive data to and from the outside.

### Reception portion 110

The reception portion 110 has a function of receiving data from the outside. As the reception portion 110, a communication port or an input device such as a personal computer having a communication function may be used, for example.

Examples of the data that the reception portion 110 receives from the first information processing device 10 include the first answer sentence and the second answer sentence output from the language model. Examples of the data that the reception portion 110 receives from the second information processing device 20 include a technical feature candidate list. Examples of the data that the reception portion 110 receives from the information terminal 40 include claim text (see FIG. 3).

The reception portion 110 can supply the received data to one or both of the memory portion 130 and the processing portion 140 through the transmission path 150.

### Output portion 120

The output portion 120 has a function of outputting an arithmetic operation result or the like to the outside. As the output portion 120, a communication port or a device such as a personal computer having a communication function may be used, for example.

Examples of the data that the output portion 120 outputs to the first information processing device 10 include the first instruction sentence and the second instruction sentence. Examples of the data that the output portion 120 outputs to the second information processing device 20 include a claim feature. Examples of the data that the output portion 120 outputs to the information terminal 40 include a technical feature list (see FIG. 3). For example, one or both of the output portion 120 and the information terminal 40 have a function of displaying a technical feature list in a table format.

### Memory portion 130

The memory portion 130 has a storage function. The memory portion 130 is a memory region, which can store a program, data, and the like. The program is typically a program to be executed by the processing portion 140. The data includes the claim text that the reception portion 110 has received from the information terminal 40, the data generated by the language model (e.g., the first answer sentence and the second answer sentence), and the technical feature candidate list output from the second information processing device 20.

The memory portion 130 may include a database. The third information processing device 30 may include a database different from that in the memory portion 130. The third information processing device 30 may have a function of extracting data from a database outside the memory portion 130, outside the third information processing device 30, or outside the text processing device. The third information processing device 30 may have a function of extracting data from both of its own database and an external database.

One or both of a storage and a file server can be used as the memory portion 130. In addition, a database in which a path of a file stored in the file server is recorded can be stored in the memory portion 130.

The memory portion 130 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The memory portion 130 may include at least one of a NOSRAM (registered trademark) and a DOSRAM (registered trademark). The memory portion 130 may include a storage media drive. Examples of the storage media drive include a hard disk drive (HDD) and a solid state drive (SSD).

Note that NOSRAM stands for "nonvolatile oxide semiconductor random access memory (RAM)". A NOSRAM refers to a memory in which a two-transistor (2T) or three-transistor (3T) gain cell is used as a memory cell and the transistor includes a metal oxide in its channel formation region (such a transistor is also referred to as an OS transistor). Current flowing between a source and a drain in an off state, that is, leakage current, is extremely low in an OS transistor. A NOSRAM retains, in memory cells, electric charge corresponding to data by using a characteristic of an extremely low leakage current, and thus can be used as a nonvolatile memory. In particular, a NOSRAM is capable of reading retained data without destruction (non-destructive reading), and thus is suitable for arithmetic processing in which only data reading operations are repeated many times. A NOSRAM can have large data capacity when stacked in layers, and thus, a semiconductor device in which a NOSRAM is used for a large-scale cache memory, a large-scale main memory, or a large-scale storage memory can have higher performance.

DOSRAM stands for "dynamic oxide semiconductor RAM" and refers to a RAM including a one-transistor (1T) and one-capacitor (1C) memory cell. A DOSRAM is a DRAM formed using an OS transistor and temporarily stores information transmitted from the outside. A DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide can be suitably used as the metal oxide included in the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high binding energy with oxygen. The element M is, for example, an element that has higher binding energy with oxygen than indium does. The metal oxide included in the channel formation region is preferably a metal oxide containing zinc (Zn). The metal oxide containing zinc is easily crystallized in some cases. For example, indium gallium zinc oxide (also referred to as IGZO) or indium tin oxide (also referred to as ITZO (registered trademark)) can be used as the metal oxide included in the channel formation region.

The metal oxide included in the channel formation region is not limited to the metal oxide containing indium. The metal oxide included in the channel formation region may be, for example, a metal oxide that does not contain indium but contains any of zinc, gallium, and tin (e.g., zinc tin oxide or gallium tin oxide).

### Processing portion 140

The processing portion 140 has a function of performing processing such as arithmetic operation and analysis with the use of data supplied from one or both of the reception portion 110 and the memory portion 130. The processing portion 140 can supply processed data to one or both of the memory portion 130 and the output portion 120.

The processing portion 140 can include an arithmetic circuit, for example. The processing portion 140 can include a central processing unit (CPU), for example. The processing portion 140 can include a graphics processing unit (GPU) in addition to or instead of the CPU. Furthermore, the processing portion 140 can include a neural processing unit/neural network processing unit (NPU).

The processing portion 140 may include a register and a main memory in addition to the CPU. The register and the main memory are sometimes included in the CPU. The main memory can transmit and receive data to and from a secondary cache or the like. The main memory includes at least one of a volatile memory such as a random access memory (RAM) and a nonvolatile memory such as a read only memory (ROM). The main memory may include at least one of a NOSRAM and a DOSRAM. The main memory can include one or both of an OS transistor and a Si transistor. Note that the structures of the register and the main memory can be understood by replacing the CPU in this paragraph with the GPU.

Examples of RAMs include a DRAM and an SRAM. In a DRAM or an SRAM, a virtual memory space can be assigned and utilized as a working space of the processing portion 140. An operating system, an application program, a program module, program data, a look-up table, and the like that are stored in the memory portion 130 are loaded into the RAM immediately before execution. The operating system, the application program, the program module, the program data, and the look-up table that are loaded into the RAM can be accessed from the processing portion 140.

A system that does not require rewriting can be stored in the ROM, for example. Examples of the system that does not require rewriting include a basic input/output system (BIOS) and firmware. Examples of the ROM include a mask ROM, a one-time programmable read only memory (OTPROM), and an erasable programmable read only memory (EPROM). Examples of the EPROM include an ultra-violet erasable programmable read only memory (UV-EPROM), which can erase stored data by irradiation with ultraviolet rays, an electrically erasable programmable read only memory (EEPROM), and a flash memory.

The processing portion 140 may include a microprocessor such as a digital signal processor (DSP) in addition to the CPU or the GPU. The DSP is specialized in digital signal processing and is thus preferably included to control a peripheral circuit and the like of the CPU or the GPU. The microprocessor may be configured with a field programmable gate array (FPGA), a field programmable analog array (FPAA), or any other programmable logic device (PLD) operated by hardware.

The third information processing device 30 has a function of creating an instruction sentence from text data with the use of the processing portion 140. Specifically, the third information processing device 30 has a function of creating the first instruction sentence that includes claim text and the first instruction, a function of creating the second instruction sentence that includes a claim feature, a technical feature candidate list, and the second instruction, and the like.

The processing portion 140 may have a function of vectorizing text to give vector data. The text vectorization can be performed using SentenceBERT or the like. Vector data refers to multidimensional numerical data.

### Transmission path 150

The transmission path 150 has a function of transmitting data. Data transmission and reception among the reception portion 110, the output portion 120, the memory portion 130, and the processing portion 140 can be performed through the transmission path 150. As the transmission path 150, for example, an external bus, a local area network (LAN), or the Internet, which is the infrastructure of the World Wide Web (WWW), may be used.

With the information processing device having the above-described example structure, a technical feature list can be obtained from claim text, which enables deeper comprehension of what technology the claim text pertains to.

### Structure Example 2 of information terminal 40

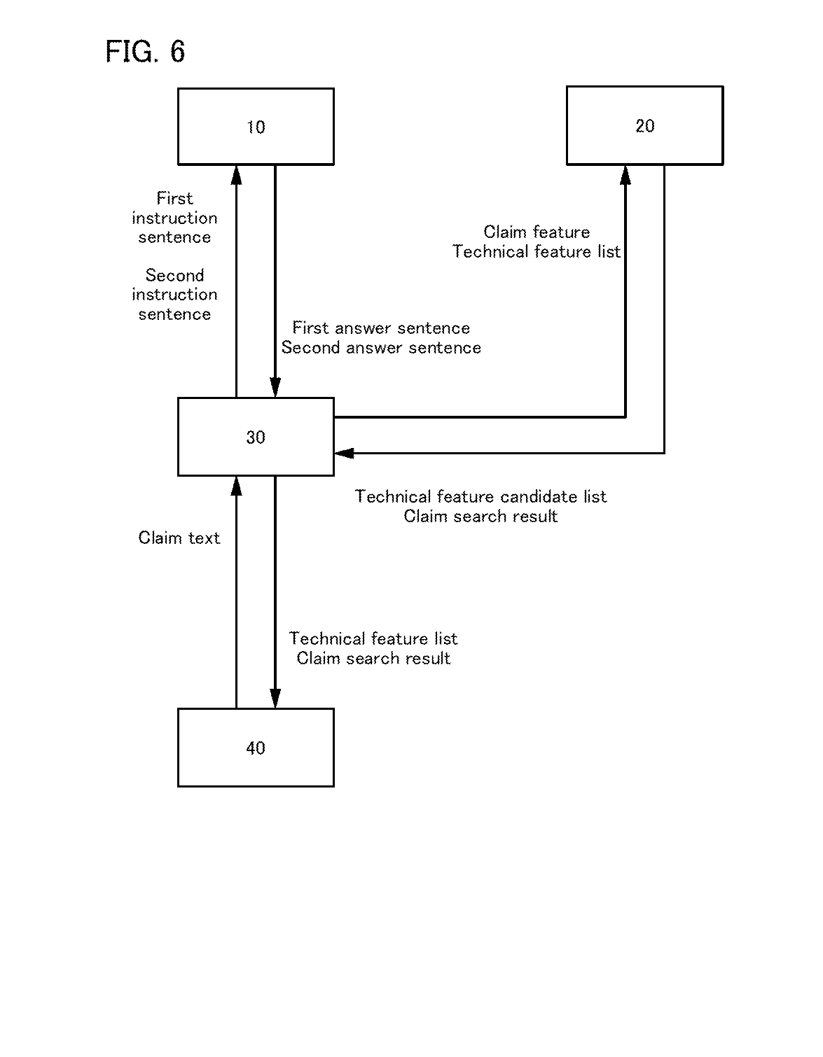

The information terminal 40 may have a function of receiving a claim search result from the third information processing device 30 (see FIG. 6).

### Structure Example 2 of second information processing device 20

Another structure example of the second information processing device 20 is described.

The second information processing device 20 has a function of performing processing using a claim database.

Specifically, the second information processing device 20 has a function of receiving a technical feature list, conducting a search, and outputting a claim search result (see FIG. 6).

The claim database is a database that stores a technical feature, claim text, and a patent identification number linked to each other. As a patent identification number, a reference number, an application number, a publication number, a registration number, or the like can be used. The claim database may include information on an applicant of a patent, information on a corresponding product, and the like.

A claim search result includes a list of technical features matching the technical features which are included in a technical feature list and for which the claim database has been searched and the claim text and the patent identification number that are linked to the technical features.

### Structure Example 2 of third information processing device 30

Another structure example of the third information processing device 30 is described.

The third information processing device 30 has a function of outputting a technical feature list to the second information processing device 20, receiving a claim search result, and outputting the claim search result to the information terminal 40 (see FIG. 6). For example, one or both of the output portion 120 of the third information processing device 30 and the information terminal 40 have a function of displaying a claim search result in a table format.

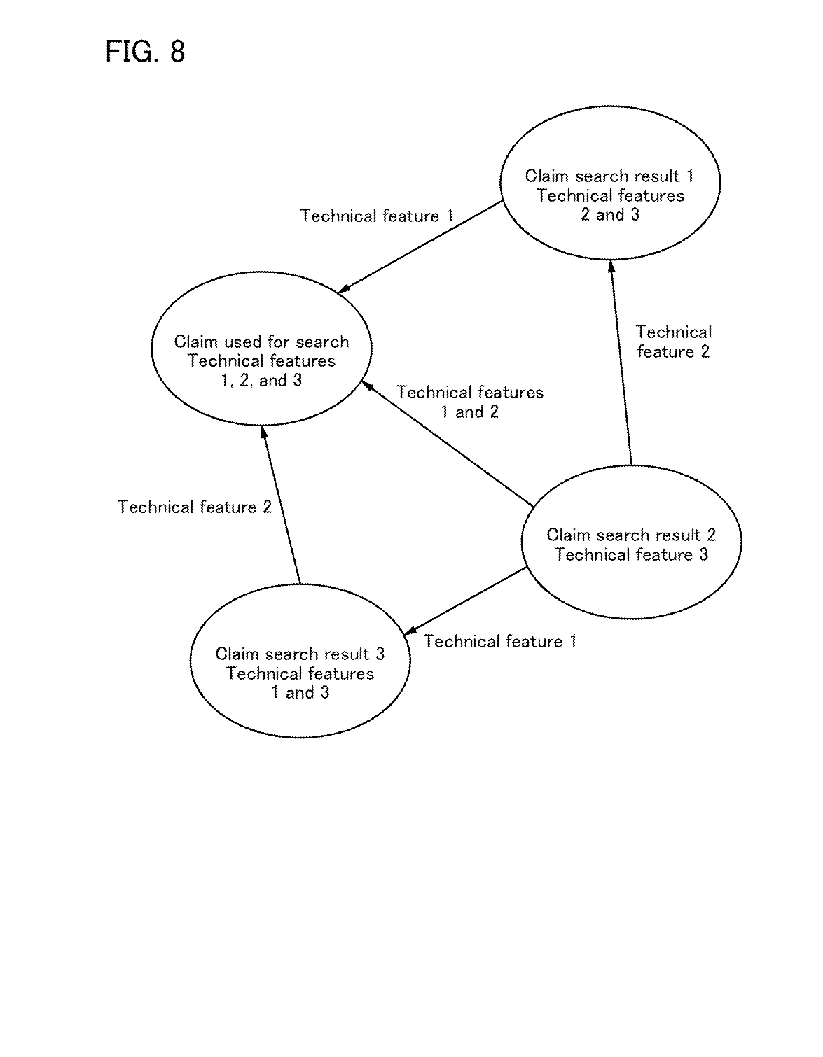

At the time of outputting a claim search result to the information terminal 40, the third information processing device 30 may construct and output a graph structure like the one illustrated in FIG. 8.

The graph structure in FIG. 8 illustrate technical features that are missing between a claim used for a search and claim search results. Outputting a graph like the one illustrated in FIG. 8 can assist the comprehension of the difference in technical features and the relationship between the claim used for the search and the claim search results.

Furthermore, the node of the graph can be displayed with metadata added thereto; for example, the node may have information on an applicant and may be color-coded. The vertical axis and horizontal axis may be set in the displayed graph, where a node with more technical features may be placed higher and a node having more edges from (being farther from) the node of the specified claim may be placed more rightward.

In the above-described structure example of the information processing device, by color-coding claims, it is possible to find out the relationship between the specified claim and its nearby claim and visualize the differentiation from the claims of others at the same time. In addition, it is possible to find out from the arrangement of the nodes whether a claim has many or few technical features and whether the claim is technically far from the specified claim.

A claim (node) from which many edges are directed and at which few edges are directed can be regarded as having a superordinate concept, whereas a claim at which many edges are directed can be regarded as having a subordinate concept. Even in the case where a claim has a subordinate concept, the claim is found to be useful when a product corresponding to the claim is registered. Accordingly, the user of the information processing device can find out the relationship between his or her patent and a patent covering a technology similar to that of his or her patent, for example.

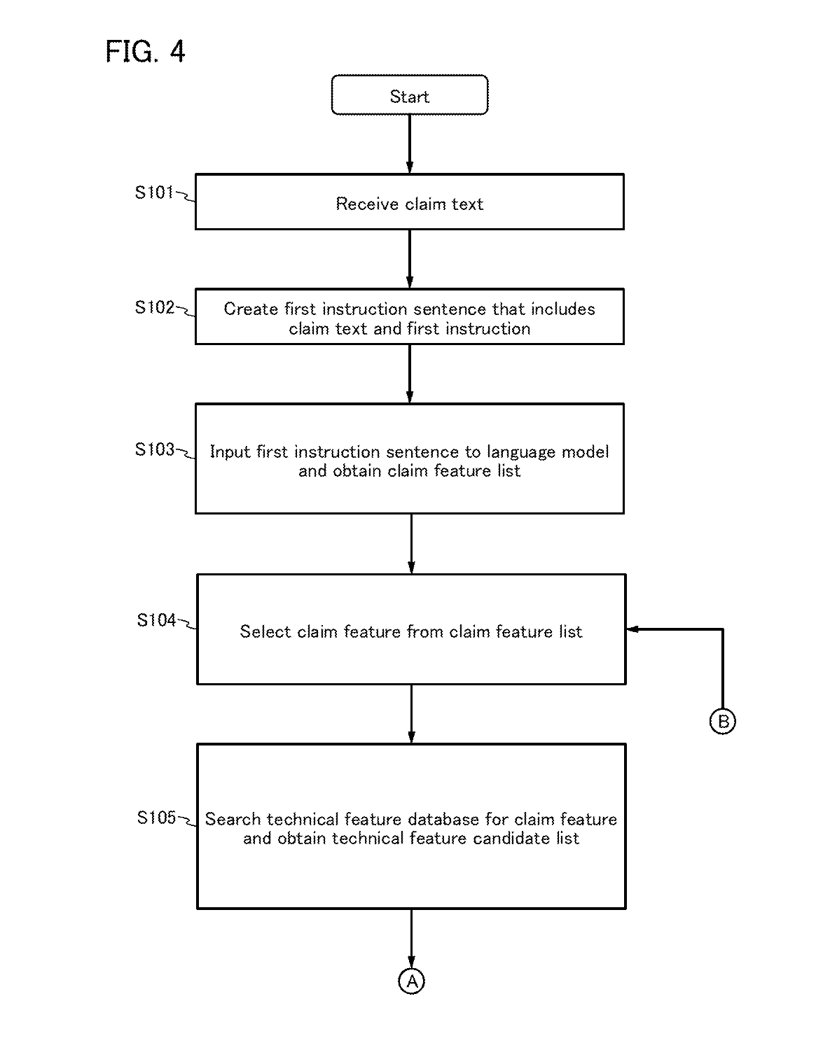

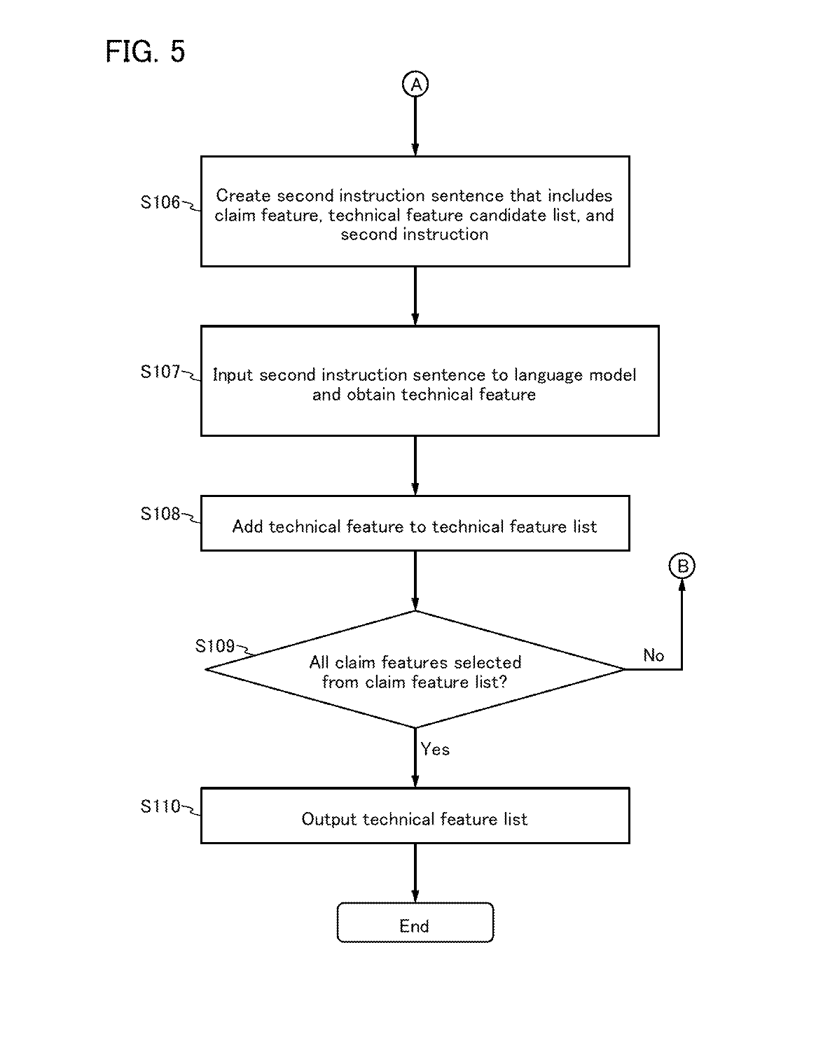

An example of the text processing method described in this embodiment is described with reference to FIG. 4 and FIG. 5.

### Example of processing by text processing method

FIG. 4 and FIG. 5 show an example of a flowchart of steps relating to the text processing method of one embodiment of the present invention.

### Step S101

In Step S101, the third information processing device 30 receives claim text from the information terminal 40.

The input work by the user corresponding to Step S101 is performed by the information terminal 40. The claim text is transmitted to the third information processing device 30 through the reception portion 110 and stored in the memory portion 130.

### Step S102

In Step S102, the third information processing device 30 creates the first instruction sentence that includes the claim text and the first instruction.

### Step S103

In Step S103, the third information processing device 30 transmits the first instruction sentence to the first information processing device 10 through the output portion 120. The first information processing device 10 inputs the first instruction sentence to the language model and generates the first answer sentence including a claim feature list. The third information processing device 30 obtains the first answer sentence through the reception portion 110.

### Step S104

In Step S104, the third information processing device 30 selects a claim feature from the claim feature list.

### Step S105

In Step S105, the third information processing device 30 transmits the claim feature to the second information processing device 20 through the output portion 120. The second information processing device 20 searches the technical feature database for the claim feature and outputs a technical feature candidate list. The third information processing device 30 obtains the technical feature candidate list through the reception portion 110.

In Step S105, the third information processing device 30 may transmit a vectorized claim feature to the second information processing device 20. In that case, the third information processing device 30 vectorizes the claim feature and transmits it to the second information processing device 20. The second information processing device 20 conducts a vector search through the technical feature database and outputs a technical feature candidate list. In this case, the technical feature database needs to store vectorized technical features and technical features of text data that are linked to each other.

### Step S106

In Step S106, with the use of the processing portion 140, the third information processing device 30 creates the second instruction sentence that includes the claim feature, the technical feature candidate list, and the second instruction.

### Step S107

In Step S107, the third information processing device 30 transmits the second instruction sentence to the first information processing device 10 through the output portion 120. The first information processing device 10 inputs the second instruction sentence to the language model and generates the second answer sentence including a technical feature. The second information processing device 20 obtains the second answer sentence through the reception portion 110.

### Step S108

In Step S108, with the use of the processing portion 140, the third information processing device 30 adds the technical feature to the technical feature list.

### Step S109

In Step S109, the third information processing device 30 determines whether all the claim features have been selected from the claim feature list; if all the claims have been selected, the process proceeds to Step S110, and if not all the claims have been selected, the process proceeds to Step S104.

Through the repetition of Steps S104 to S109, the technical feature list shows what technical field the claim text pertains to. The technical feature list is the result of multilabel classification of the claim text and can be used as one or more labels or tags added to the claim text.

### Step S110

In Step S110, the third information processing device 30 outputs the technical feature list to the information terminal 40 through the output portion 120.

By such a text processing method, a technical feature of claim text can be obtained, enabling deeper comprehension of the claim text.

### Variation example of text processing method

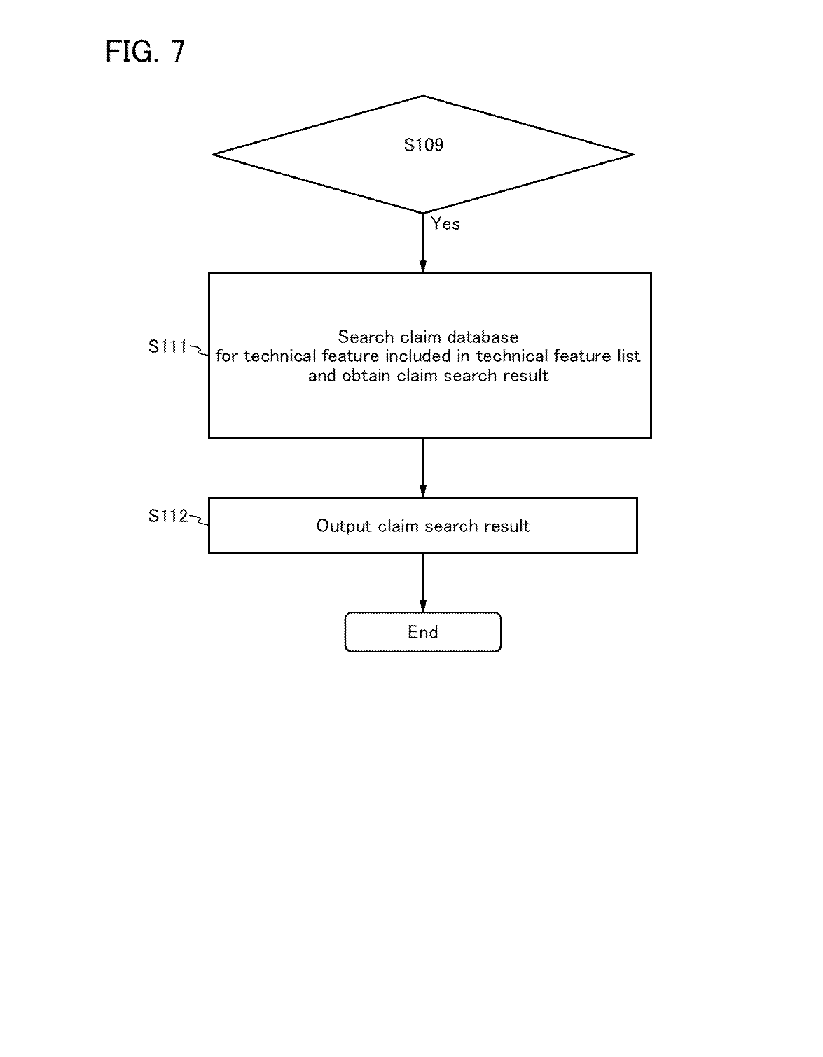

FIG. 7 is a flowchart of a variation example of the text processing method. In FIG. 7, Steps S111 and S112 are performed instead of Step S110.

### Step S111

In Step S111, the third information processing device 30 transmits a technical feature list to the second information processing device 20 through the output portion 120. The second information processing device 20 searches the claim database for the technical feature included in the technical feature list and outputs a claim search result. The third information processing device 30 obtains the claim search result through the reception portion 110.

### Step S112

In Step S112, the third information processing device 30 outputs the claim search result to the information terminal 40 through the output portion 120.

With the use of such a variation example of the text processing method, information on a patent having the same technical feature as claim text can be obtained. Accordingly, the user of the information processing device can find out the relationship between his or her patent and a patent covering a technology similar to that of his or her patent, for example.

This application is based on Japanese Patent Application Serial No. 2025-014652 filed with Japan Patent Office on January 31, 2025, the entire contents of which are hereby incorporated by reference.

What is claimed is:

1. A text processing device comprising:
a first information processing device;
a second information processing device; and
a third information processing device,
wherein the first information processing device is configured to:
receive a first instruction sentence, perform processing using a language model, and output a first answer sentence; and
receive a second instruction sentence, perform processing using the language model, and output a second answer sentence,
wherein the first instruction sentence comprises claim text and a first instruction,
wherein the first instruction comprises an instruction to generate a claim feature list from the claim text,
wherein the first answer sentence comprises the claim feature list,
wherein the second instruction sentence comprises one claim feature selected from the claim feature list, a technical feature candidate list, and a second instruction,
wherein the second instruction comprises an instruction to select a technical feature corresponding to the claim feature from the technical feature candidate list,
wherein the second answer sentence comprises the technical feature,
wherein the second information processing device is configured to receive the claim feature, search a technical feature database for the claim feature, and output the technical feature candidate list, and
wherein the third information processing device is configured to:
receive the claim text;
create the first instruction sentence;
transmit the first instruction sentence to the first information processing device and receive the first answer sentence;
select one claim feature from the claim feature list sequentially as the claim feature of the second instruction sentence;
transmit the claim feature to the second information processing device and receive the technical feature candidate list;
create the second instruction sentence;
transmit the second instruction sentence to the first information processing device and receive the second answer sentence;
add the technical feature to a technical feature list; and
output the technical feature list.

2. The text processing device according to claim 1,
wherein the second information processing device is configured to receive the technical feature list, search a claim database for the technical feature included in the technical feature list, and output a claim search result,
wherein the claim database is configured to store the claim text, the technical feature, and an identification number linked to each other,
wherein the claim search result comprises the technical feature, and the claim text and the identification number linked to the technical feature, and
wherein the third information processing device is configured to:
transmit the technical feature list to the second information processing device and receive the claim search result; and
output the claim search result.

3. A text processing method comprising the steps of:
receiving claim text;
creating a first instruction sentence comprising the claim text;
inputting the first instruction sentence to a language model to generate a claim feature list from the claim text;
selecting one claim feature from the claim feature list;
searching a technical feature database for the claim feature to obtain a technical feature candidate list;
creating a second instruction sentence comprising the claim feature and the technical feature candidate list;
inputting the second instruction sentence to the language model to select a technical feature corresponding to the claim feature from the technical feature candidate list;
adding the technical feature to a technical feature list; and
outputting the technical feature list.

4. A text processing method comprising:
a first step, a second step, a third step, a fourth step, a fifth step, a sixth step, a seventh step, an eighth step, a ninth step, and a tenth step,
wherein in the first step, claim text is received,
wherein in the second step, a first instruction sentence is created,
wherein the first instruction sentence comprises the claim text and a first instruction,
wherein the first instruction comprises an instruction to generate a claim feature list from the claim text,
wherein in the third step, the first instruction sentence is input to a language model and a first answer sentence is obtained,
wherein the first answer sentence comprises the claim feature list,
wherein in the fourth step, one claim feature is selected from the claim feature list,
wherein in the fifth step, a technical feature database is searched for the claim feature and a technical feature candidate list is obtained,
wherein in the sixth step, a second instruction sentence is created,
wherein the second instruction sentence comprises the claim feature, the technical feature candidate list, and a second instruction,
wherein the second instruction comprises an instruction to select a technical feature corresponding to the claim feature from the technical feature candidate list,
wherein in the seventh step, the second instruction sentence is input to the language model and a second answer sentence is obtained,
wherein the second answer sentence comprises the technical feature,
wherein in the eighth step, the technical feature is added to a technical feature list,
wherein in the ninth step, whether all the claim features have been selected from the claim feature list is determined, a process proceeds to the tenth step when all the claim features have been selected, and the process proceeds to the fourth step when not all the claim features have been selected, and
wherein in the tenth step, the technical feature list is output.

5. The text processing method according to claim 4,
wherein the ninth step is followed by an eleventh step and a twelfth step instead of the tenth step,
wherein in the eleventh step, a claim database is searched for the technical feature included in the technical feature list and a claim search result is obtained,
wherein the claim database is configured to store the claim text, the technical feature, and an identification number linked to each other,
wherein the claim search result comprises the technical feature, and the claim text and the identification number linked to the technical feature, and
wherein in the twelfth step, the claim search result is output.
